(19) United States
(12) Patent Application Publication
(10) Pub. No.: US 2009/0135594 A1
(43) Pub. Date: May 28, 2009

(54) HEAT DISSIPATION DEVICE USED IN LED LAMP

(75) Inventors: FANG-XIANG YU, Shenzhen City (CN); SHUN-YUAN JAN, Tu-Cheng (TW); CHUNG-YUAN HUANG, Santa Clara, CA (US)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/275,206

(22) Filed: Nov. 20, 2008

(30) Foreign Application Priority Data
Nov. 23, 2007 (CN) 200710124771.1

(51) Int. Cl. F21V 29/00

(52) U.S. Cl. 362/234

(57) ABSTRACT

A heat dissipation device (100) for dissipating heat of LEDs (80) includes a heat sink (10). The heat sink includes a plurality of fins (12). Each of the plurality of fins defines a plurality of notches (120) in a peripheral edge thereof. The fins are spaced from each other from top to bottom. The notches coincide with each other from top to bottom so as to form a plurality of vertical air channels (122) in a periphery of the heat sink. A thermal base (40) has a bottom face to which the LEDs are attached. A U-shaped heat pipe (30) has an evaporator (32) connected to the thermal base and a condenser (35) extending upwardly through the fins.

### BACKGROUND

1. Technical Field

The disclosure relates to heat dissipation devices, and more particularly to a heat dissipation device incorporated in an LED lamp for dissipating heat generated by LEDs of the LED lamp.

2. Description of Related Art

As an energy-efficient light source, an LED lamp has a trend of substituting the fluorescent lamp for a lighting purpose. In order to increase the overall lighting brightness, a plurality of LEDs are often incorporated into a lamp. It is well known that the LEDs generate a lot of heat when emit heat. If the heat cannot be quickly removed, the LED lamp may be overheated, significantly reducing work efficiency and service life thereof. Therefore, how to efficiently dissipate the heat generated by the LEDs becomes a challenge in designing the LED lamp.

What is needed, therefore, is a heat dissipation device which can efficiently dissipate the heat of the LEDs of the LED lamp.

### SUMMARY

A heat dissipation device according to an exemplary embodiment includes a heat sink. The heat sink includes a plurality of fins. Each of the plurality of fins defines a plurality of notches in a peripheral edge thereof. The fins are stacked along a bottom-to-top direction and spaced from each other a distance. The notches coincide with each other along the bottom-to-top direction so as to form a plurality of vertical air channels in a periphery of the heat sink.

Other advantages and novel features of the present invention will become more apparent from the following detailed description when taken in conjunction with the accompanying drawings.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an exploded, isometric view of an LED lamp incorporating a heat dissipation device in accordance with a first embodiment, wherein only a top fin is separated from the heat dissipation device.

FIG. 2 is an assembled, isometric view of the heat dissipation device of FIG. 1, shown from an opposite bottom aspect.

FIG. 3 is an isometric view of a heat dissipation device in accordance with a second embodiment.

FIG. 4 is an assembled, isometric view of a heat dissipation device in accordance with a third embodiment.

FIG. 5 is an assembled, isometric view of a heat dissipation device in accordance with a fourth embodiment.

### DETAILED DESCRIPTION

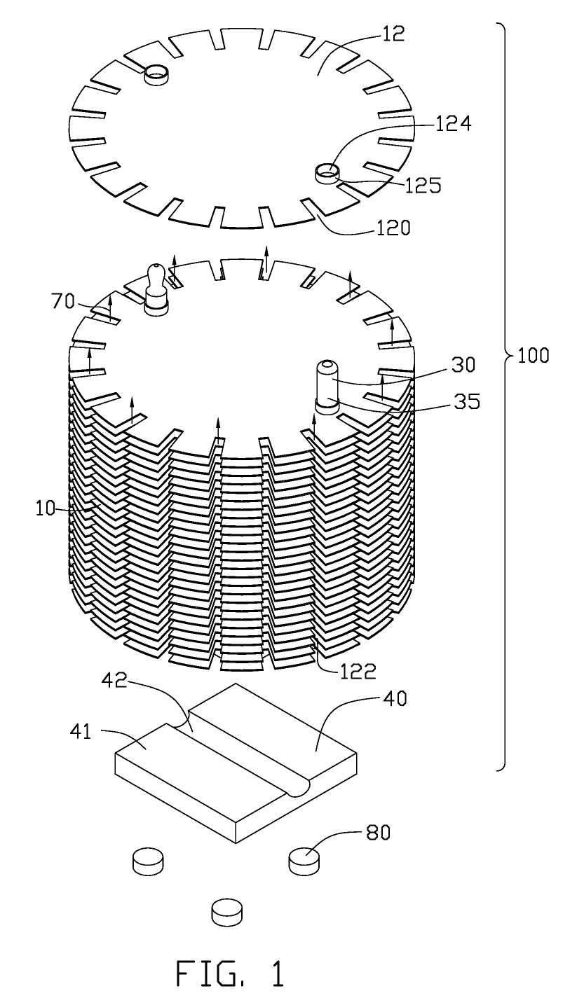

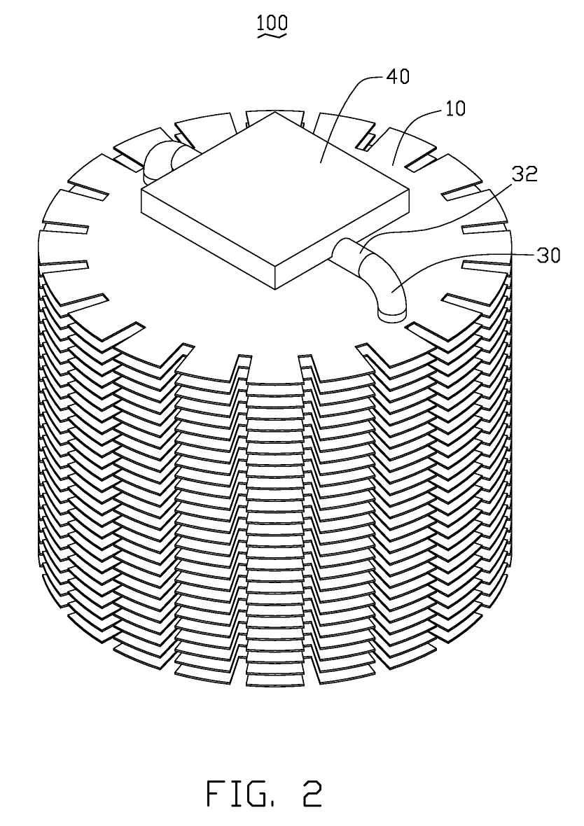

Referring to FIGS. 1 and 2, an LED lamp including a heat dissipation device 100 and a plurality of LEDs 80 is shown. The heat dissipation device 100 is used to dissipate heat generated by the LEDs 80. The heat dissipation device 100 includes a heat sink 10, a heat pipe 30 and a thermal base 40. The heat pipe 30 is bended to have a generally U-shaped configuration. Two ends of the heat pipe 30 extend upwardly through the heat sink 10. A bottom portion of the heat pipe 30 is engaged with a top of the thermal base 40. The LEDs 80 are attached to a bottom of the thermal base 40.

The thermal base 40 is made of a material having good heat conductivity, such as copper or aluminum. The thermal base 40 has a top surface 41. The top surface 41 of the thermal base 40 spaces from a bottom of the heat sink 10. The top surface 41 of the thermal base 40 defines a horizontal groove 42 receiving the bottom portion of the heat pipe 30 therein.

The heat sink 10 has a cylindrical shape and comprises a plurality of circular fins 12. The fins 12 are stacked one above another with a gap defined between two adjacent ones. A plurality of rectangular notches 120 are defined in a circumferential edge of each fin 12. The notches 120 of each fin 12 are spaced from each other and located evenly along the circumferential edge of each fin 12. The notches 120 of the fins 12 coincide with each other from top to bottom so as to form a plurality of vertical air channels 122 in a periphery of the heat sink 10.

The air channels 122 communicate air below the heat sink 10 with air above the heat sink 10. Each of the fins 12 defines two circular holes 124. The notches 120 and the holes 124 are formed by stamping corresponding parts of the fins 12. Two flanges 125 extend upwardly from a top surface of each fin 12. Each of the flanges 125 corresponds to and surrounds a peripheral edge of one of the holes 124 of each fin 12. The fins 12 are equidistantly spaced from each other via the flanges 125 abutting against the adjacent fins 12. The holes 124 of the fins 12 coincide with each other from top to bottom, thereby forming two circular channels for engagingly receiving two vertical portions of the heat pipe 30.

The heat pipe 30 has a horizontal evaporator 32 and two vertical condensers 35. The two condensers 35 are respectively connected to two ends of the evaporator 32. A vertical length of the condenser 35 of the heat pipe 30 is longer than a vertical length of the heat sink 10. The condensers 35 of the heat pipe 30 are extended through and soldered in the holes 124 of the fins 12 so as to assemble the fins 12 together to form the heat sink 10. The condensers 35 are located adjacent to the notches 120. The evaporator 32 of the heat pipe 30 is conformably received and soldered in the groove 42 of the base 40. In the preferred embodiment, the heat pipe 30, the base 40 and the fins 12 are assembled together by soldering. Alternatively, the heat pipe 30, the base 40 and the fins 12 can be assembled together by thermally conductive glue spread in the holes 124 and the groove 42.

In operation, heat generated by the LEDs 80 is firstly absorbed by the thermal base 40; then a portion of the heat of the thermal base 40 is transferred to the heat pipe 30, and further transferred to the fins 12 of the heat sink 10. Another portion of the heat of the thermal base 40 is transferred to air around the thermal base 40 directly. Then the heated air floats upwardly through the vertical channels 122 of the heat sink 10 as indicated by arrows 70 of FIG. 1, and exchanges heat with the fins 12 to take the heat of the fins 12 upwardly into ambient cool air. The vertical channels 122 provide a smooth passage for the heated air to disperse upwardly and contact more areas of the fins 12. Thus, the heated air surrounding the thermal base 40 and the heat in the fins 12 can be more easily dissipated to the ambient cool air. A heat dissipation efficiency of the heat dissipation device 100 is thereby improved.

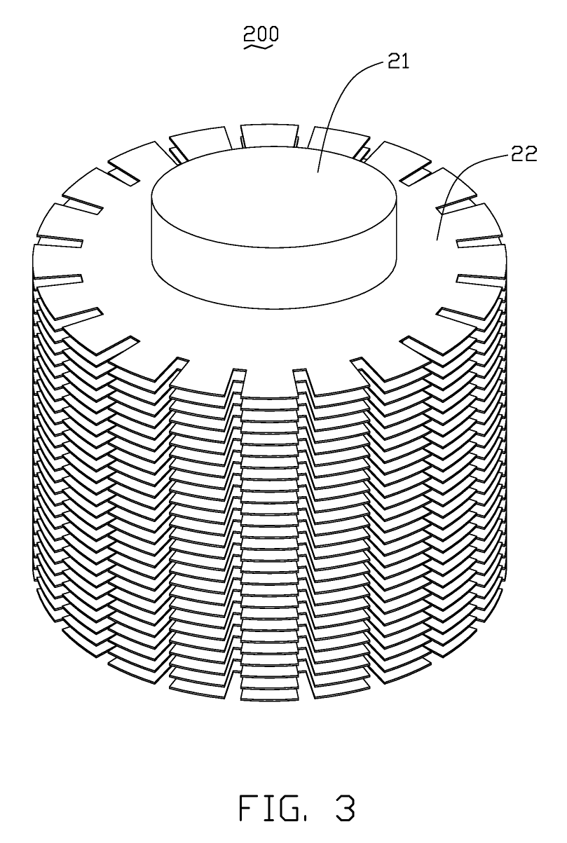

Referring to FIG. 3, a heat dissipation device 200 in accordance with a second embodiment is shown. The heat dissipation device 200 differs from the heat dissipation device 100 in that the heat dissipation device 200 comprises a central column 21 and a plurality of fins 22. The fins 22 extend outwardly and securely from a periphery of the central column 21 and spaced from each other vertically. The central column 21 is made of a material having a good heat conductivity, such as copper or aluminum.

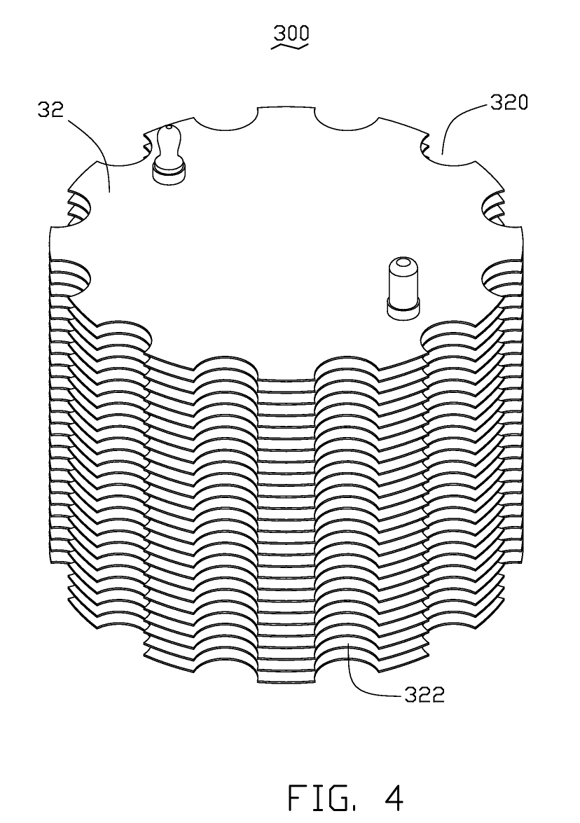

Referring to FIG. 4, a heat dissipation device 300 in accordance with a third embodiment is shown. The heat dissipation device 300 differs from the heat dissipation device 100 in that notches 320 defined in fins 32 of the heat dissipation device 300 are semicircular. A plurality of air channels 322 are formed by the notches 320 and extend vertically from top to bottom.

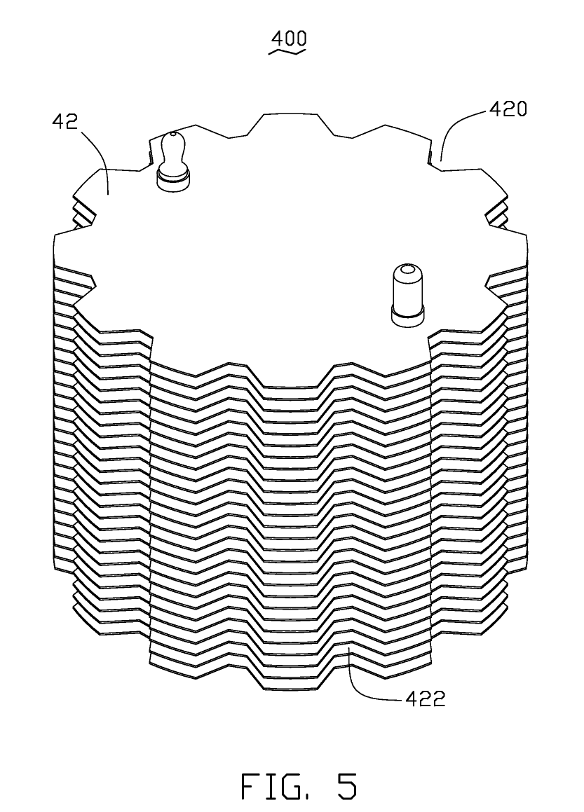

Referring to FIG. 5, a heat dissipation device 400 in accordance with a fourth embodiment is shown. The heat dissipation device 400 differs from the heat dissipation device 100 in that notches 420 defined in fins 42 of the heat dissipation device 400 are trapeziform. A plurality of air channels 422 are formed by the notches 420 and extend vertically from top to bottom.

The notches 320, 420 are bigger than the notches 120 so that the air channels 322, 422 formed by the notches 320, 420 respectively can accommodate more heated air than the air channels 122. Accordingly, the heated air can contact more areas of the fins 32, 42 to bring more heat of the fins 32, 42 to flow upwardly. Therefore, the heat dissipation devices 300, 400 each have higher heat dissipation efficiency.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A heat dissipation device for an LED lamp having a plurality of LEDs, comprising:
a heat sink adapted for dissipating heat generated by the LEDs of the LED lamp, comprising a plurality of fins stacked one above another along a bottom to top direction and spaced from each other with a gap between two adjacent fins, each of the plurality of fins defining a plurality of notches in a peripheral edge thereof, the notches of the fins coinciding with each other along the bottom to top direction so as to form a plurality of vertical air channels in a periphery of the heat sink.

2. The heat dissipation device as claimed in claim 1, wherein the notches each have a shape selected from a group consisting of rectangle, semicircle and trapezium.

3. The heat dissipation device as claimed in claim 1, wherein the notches are spaced from each other and located evenly along the peripheral edge of each fin.

4. The heat dissipation device as claimed in claim 1 further comprising a heat pipe, wherein the heat pipe includes an evaporator and two condensers, and the condensers are respectively connected to two ends of the evaporator and extend upwardly through the fins.

5. The heat dissipation device as claimed in claim 4, further comprising a thermal base, wherein the thermal base is located below the heat sink and engaged with the evaporator of the heat pipe, the thermal base having a bottom face adapted for thermally connecting with the LEDs of the LED lamp.

6. The heat dissipation device as claimed in claim 4, wherein the condensers of the heat pipe are located adjacent to the notches.

7. The heat dissipation device as claimed in claim 1, wherein the fins are circular-shaped so that heat sink has a cylindrical shape, and the notches are located in a circumferential edge of each of the fins.

8. The heat dissipation device as claimed in claim 1, wherein the heat sink comprises a central column, and the fins extend outwardly and securely from a periphery of the central column.

9. An LED lamp comprising:
a heat dissipation device comprising a plurality of fins stacked one above another with a gap defined between two adjacent ones, a plurality of notches defined in a peripheral edge of each of the fins, the notches coinciding with each other from top to bottom so as to form a plurality of vertical air channels in a periphery of the fins;
at least one heat pipe having an evaporator and a condenser extending upwardly from the evaporator through the fins;
a thermal base attached to the evaporator of the at least one heat pipe;
at least one LED thermally connected to a bottom of the thermal base.

10. The LED lamp as claimed in claim 9, wherein the notches each have a shape selected from a group consisting of rectangle, semicircle and trapezium.

11. The LED lamp as claimed in claim 9, wherein the notches are spaced from each other and located evenly along the peripheral edge of each fin.

12. The LED lamp as claimed in claim 9, wherein the condenser of the heat pipe through the fins is located adjacent to the notches.
